(19) United States
(12) Patent Application Publication
(10) Pub. No.: US 2004/0144500 A1
(43) Pub. Date: Jul. 29, 2004

(54) Modularized power mechanism of blind

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: NIEN MADE ENTERPRISE CO., LTD., TAICHUNG (TW)

(21) Appl. No.: 10/419,795

(22) Filed: Apr. 22, 2003

(30) Foreign Application Priority Data
Jan. 27, 2003 (TW) 92201453

(51) Int. Cl. E06B 9/30

(52) U.S. Cl. 160/170

(57) ABSTRACT

A modularized power mechanism of blind is disclosed to include a main body, a winding unit, a transmission member and a resilient element. The main body has a first shaft hole and a second shaft hole substantially perpendicular to the first shaft hole. The winding unit is inserted into the first shaft hole of the main body and has a driving portion and a mounting hole for accommodating a reel of a blind therein. The transmission member is inserted into the second shaft hole of said main body and has a driven portion engaged with the driving portion of the winding unit for rotating synchronously. The resilient element has an end fixed to the main body and the other end fixed to the transmission member for providing a resilient force.

### BACKGROUND OF THE INVENTION

1. Field of the Invention

The present invention relates generally to the blinds, and more particularly to a modularized power mechanism of blind.

2. Description of the Prior Art

A conventional blind is typically composed of a head rail, a bottom rail and a lift cord. There are many slats tied in series by two ladder tapes between the head rail and the bottom rail to construct a Venetian blind, or a cloth shade maybe fitted instead of slats between the head rail and the bottom rail to form a roller blind. No matter what type of blind they may be, all of them directly or indirectly roll up or unroll the blinds by controlling the lift cord's winding and release. The sunshade area of a unrolled blind may vary with the occasion that blind is utilized, it can be either a blind with a longer extended area or a blind with a wider shade area; however, the gravitational weight formed at the time of unrolling the foregoing blind is in connection with the size of sunshade area and the selected slat. A blind having a wider or longer shade area or a heavier material of slat, etc. may lead to an increase of total weight in rolling up the blind; vice versa, the user has to exert a bigger force to overcome the load in order to achieve the purpose of rolling up the blind; therefore, it would be laborious while rolling up the blind.

Nevertheless, in order to access a labor-saving method for the user to roll up the blind, the commercial provider will take the advantage of reel in association with a resilient mechanism mounted on the abovementioned blind to roll up the lift cord so that the resilient mechanism can bear the fractional or entire hanging-down load of blind at its any unrolled position; after that, its resilient strength is released to obtain the labor-saving effect while rolling up the blind.

Even so, for practical consideration, normally the transverse width would become bigger after combining the resilient mechanism and the reel together, that is the reason why the head rail with resilient mechanism installed may have a width in excess of the width of slat that make the slat set unable to be fitted against the edge of window after the blind is mounted; this serious problem disfigures the overall neatness and appearance of blind, particularly for the blind with a small size slat, such as the slat of 1″ span, the problem is more noticeably serious. In addition, with respect to the weight of blind in different specifications, the conventional resilient mechanism has to be applied various elastic parts and relevant accessories which may lack of the compatibility and heighten the cost of commercial provider; no wonder the unit price of product in this category stays at a high level and affect the purchasing desire of consumer. The amelioration against the said drawbacks is truly the most longing thing for the commercial provider.

### SUMMARY OF THE INVENTION

The primary objective of the present invention is to provide a modularized power mechanism of blind that can be particularly fitted to the blind with a reel mounted to roll up the blind easily and labor-saving; also, it can narrow the width of head rail on the said blind where its overall neatness and beauty is enhanced.

The other objective of the invention is the provision of a stand-alone module, the modularized power mechanism, that is, appropriate number of modules can be mounted directly to cope with the weight of blind in different specifications so that the promptness, convenience with compatibility plus cost reduction are attainable.

The foregoing objectives of the present invention are attained by a modularized power mechanism of blind comprising a main body, a winding unit, a transmission member and a resilient element. The main body has a first shaft hole and a second shaft hole substantially perpendicular to the first shaft hole. The winding unit is inserted into the first shaft hole of the main body and has a driving portion and a mounting hole for accommodating a reel of a blind therein. The transmission member is inserted into the second shaft hole of said main body and has a driven portion engaged with the driving portion of the winding unit for rotating synchronously. The resilient element has an end fixed to the main body and the other end fixed to the transmission member for providing a resilient force.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a sectional view taken along line 3-3 of FIG. 1

FIG. 4 is a partial right view of the first preferred embodiment of the present invention.

FIG. 5 is a perspective view of the first preferred embodiment of the present invention showing an alternative form of the invention.

FIG. 6 is a partial sectional view of a second preferred embodiment of the present invention.

FIG. 7 is a partial sectional view of a third preferred embodiment of the present invention.

### DETAILED DESCRIPTION OF THE INVENTION

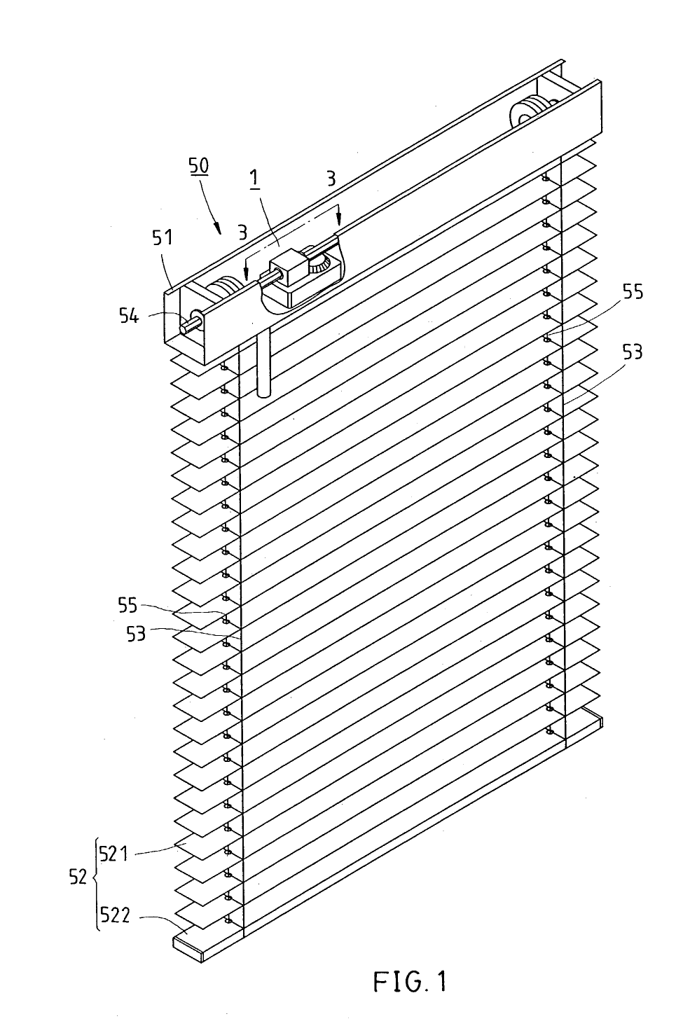

Referring to FIG. 1, a modularized power mechanism 1 of the first preferred embodiment of the invention is mounted onto a blind 50 where the blind 50 is comprised of a head rail 51, a slat set 52, two ladder tapes 53, a reel 54 and two lift cords 55. The head rail 51 is firmly mounted on the top of a window. The slat set 52 has several slats 521 and a bottom rail 522. Each ladder tape 53 has one end jointed into the head rail 51 that can perform an upward and downward micro-motion under the control of a frequency-modulating mechanism. The frequency-modulating mechanism is a conventional structure that is irrelevant to the inventive spirit of this case, so it is not shown on the Figure. While the other end of each ladder tape is connected to the bottom rail 522, also each ladder tape 53 is stringed with slats 521 in series in between the head rail 51 and the bottom rail 522. The reel 54 is a slender rod of hexagonal column shape with its two ends pivoted to the head rail 51 and its axial direction parallel to the major axis of head rail 51. The two lift cords 55 have their one end rolled up and kept at the reel 54 separately and let the cord go downward to pass through the individual slat 521 and retain the other end at the bottom rail 522; once the reel 54 is rotating, it will roll up or unroll the two lift cords 55 and then drive the slat set 52 to go up or down so that the variation of overall rolling-up or unrolling range of blind is available. Since the forgoing devices are conventionally known to the one skilled in the relative art, no further description is prepared in this regard.

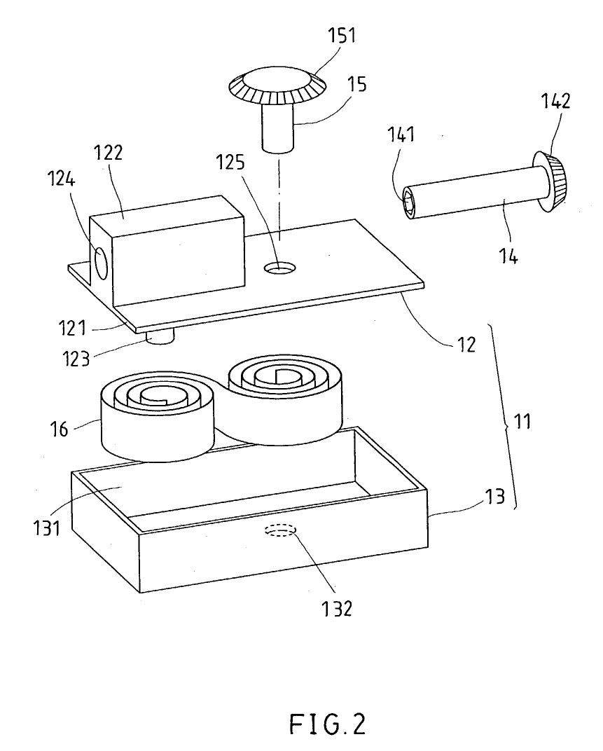

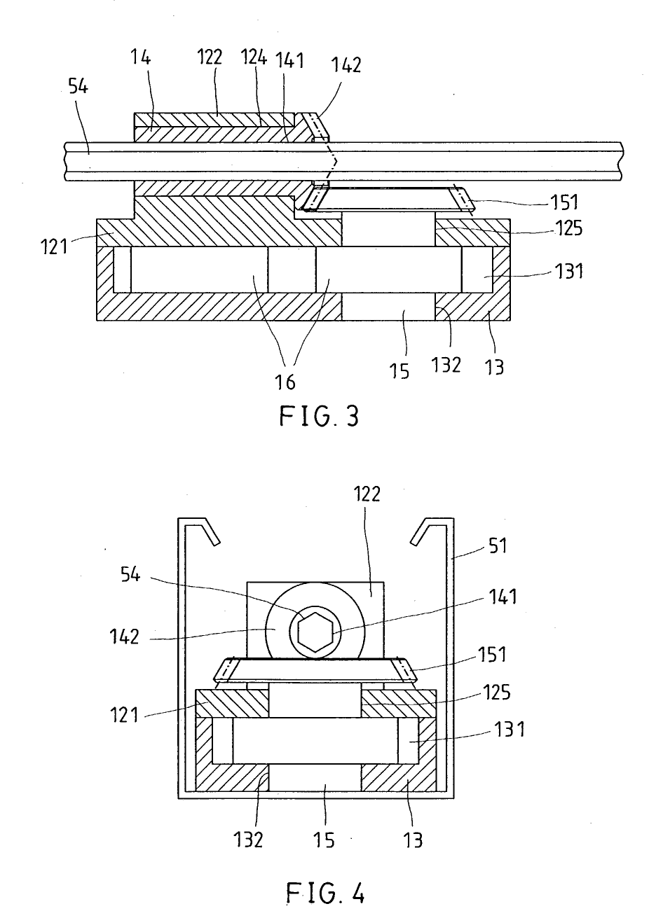

Please refer to the FIGS. 2-4, the modularized power mechanism 1 of blind in the present invention is firmly fixed onto the internal bottom surface of the head rail 51 with the reel 54 associated. The modularized power mechanism 1 of blind comprises a main body 11, a winding unit 14, a transmission member 15 and a resilient element 16.

The main body 11 includes an upper retaining bracket 12 and a lower holder 13, wherein, the upper retaining bracket 12 has a flat plate 121 with a base 122 protruded on the top side of the plate 121 and a stem 123 extended at the bottom side of the plate 121; and the base 122 has been machined a first shaft hole 124 having the axial direction identical to the reel's axial direction; also, the flat plate 121 has been opened a second shaft hole 125 to have the axial line of these two shaft holes 124 and 125 orthogonal substantially. The lower holder 13 is generally in a block body with a compartment 131 recessed downward, and the top edge of compartment 131 is mutually and firmly connected to the flat plate 121 of the upper retaining bracket 12, also, the bottom end of the compartment 131 has been opened a shaft hole 132 that has the concentric axis upward & downward corresponding to the second shaft hole 125 of the upper retaining bracket 12.

The winding unit 14 having a mounting hole 141 and a driving portion 142 is inserted into the first shaft hole 124. The mounting hole 141 of the winding unit 14 has the same cross-section in radial direction as the reel's cross-section in the radial direction so as to receive the reel 54 and enable the winding unit 14 to rotate synchronously with the reel 54. The driving portion 142 of the winding unit 14 is embodied as a bevel gear.

The transmission member 15 is inserted into the second shaft hole 125 of the upper retaining bracket 12 and the shaft hole 132 of the lower holder 13. The transmission member 15 has a driven portion 151, i.e. a bevel gear in this embodiment, coupled with the driving portion 142.

The resilient element 16 is a spiral spring with one end fixed firmly to the stem 123 of the upper retaining bracket 12 and the other end coiled at the transmission member 15 so that a resilient force is provided when the transmission member 15 and the winding unit 14 rotate together.

The primary advantages of the preferred embodiment are It can not only achieve the labor-saving effectiveness for the user to leisurely roll up the blind through the aid of resilient force exerted by the resilient element 16, but it also arranges to have the axial direction of winding unit 14 and transmission member 15 substantially perpendicular to each other so that the overall width of the head rail 51 on which the power mechanism 1 is mounted can be largely narrowed and the width of the head rail 51 of the blind 50 will not be over the width of the slat set 52. An integrally neat and beautiful blind 50 is attainable.

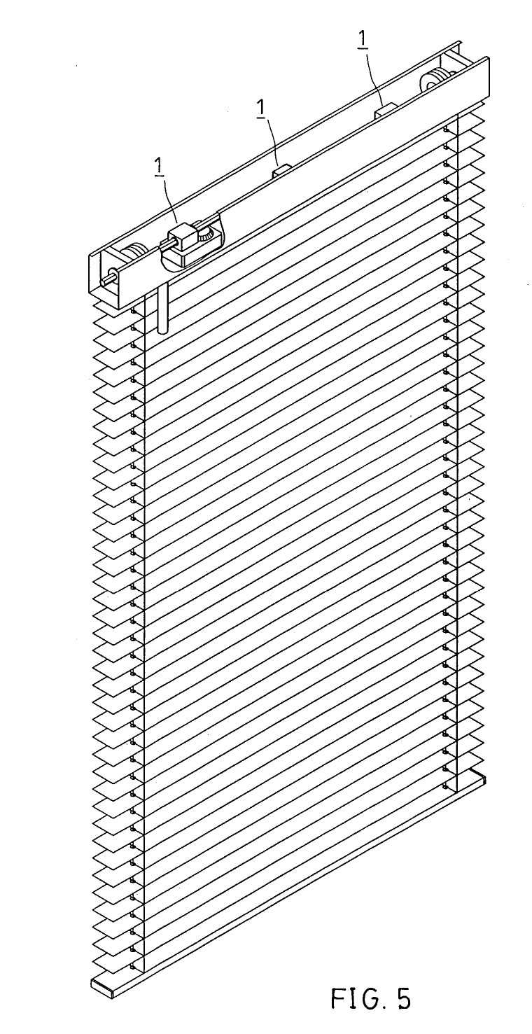

In additional, please refer to FIG. 5, showing three power mechanisms 1 of the preferred embodiment mounted in the head rail of the blind 50 that is under a condition of heavier weight. By taking the limited resilient force exerted by the power mechanism 1 of a single module into consideration, the feature to take the advantage of this power mechanism 1 as the stand-alone module may go with the overall load of the blind 50 and equip the reel 54 directly with appropriate set number of power mechanism 1 to cope with the loading demand. With the convenience of prompt assembly plus the compatibility, the cost is reduced largely.

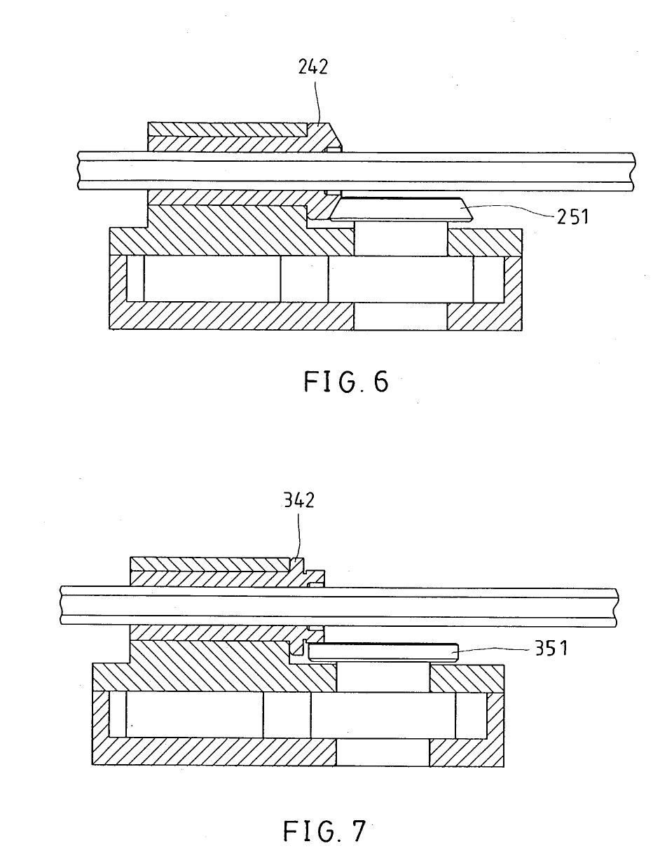

Referring to FIGS. 6 and 7, the driving portion of the winding unit and the driven portion of the transmission member of the second and the third preferred embodiments of the present invention are embodied as a pair of truncated cone friction wheels and a pair of orthogonal friction wheels. As shown in FIG. 6, the driven portion 251 and the driving portion 242 are engaged with each other such that they can rotate synchronously. As shown in FIG. 7, the driven portion 351 and the driving portion 342 are circular discs. The disc rim of the driving portion 342 is fitted against the disc facet of the driven portion 351 such that they can clench and rub with each other to rotate synchronously. These two preferred embodiments also offer the same effective advantages like the foregoing embodiment.

What is claimed is:

1. A modularized power mechanism of blind adapted to be used in association with a reel of a blind, comprising:
a main body having a first shaft hole and a second shaft hole substantially perpendicular to the first shaft hole;
a winding unit inserted into the first shaft hole of said main body, said winding unit having a mounting hole and a driving portion, wherein the mounting hole has a cross section identical to that of the reel of the blind for accommodating the reel of the blind therein;
a transmission member inserted into the second shaft hole of said main body, said transmission member having a driven portion engaged with the driving portion of said winding unit for rotating synchronously; and
a resilient element having an end fixed to said main body and the other end fixed to said transmission member for providing a resilient force.

2. The modularized power mechanism of blind as defined in claim 1, wherein the main body comprises a upper retaining bracket and a lower holder; wherein the upper retaining bracket has a flat plate that has said second shaft hole and a base protruded on a top side of the flat plate and provided with said first shaft hole base; wherein the lower holder is a block body having a compartment recessed inward; wherein a top edge of the compartment is mutually and firmly connected to the flat plate of the upper retaining bracket, and a bottom end of the compartment has a shaft hole coaxially corresponding to the second shaft hole of the upper retaining bracket.

3. The modularized power mechanism of blind as defined in claim 1, wherein the driving portion of the winding unit and the driven portion of the transmission member are a pair of bevel gears engaged with each other.

4. The modularized power mechanism of blind as defined in claim 1, wherein the driving portion of the winding unit and the driven portion of the transmission member are a pair of truncated cone friction wheels engaged with each other.

5. The modularized power mechanism of blind as defined in claim 1, wherein the driving portion of the winding unit and the driven portion of the transmission member are a pair of orthogonal friction wheels engaged with each other.

6. The modularized power mechanism of blind as defined in claim 1, wherein the resilient element is a spiral spring.

7. The modularized power mechanism of blind as defined in claim 1, wherein the resilient element is a torsional spring.
